(19) United States
(12) Patent Application Publication
(10) Pub. No.: US 2025/0118795 A1
(43) Pub. Date: Apr. 10, 2025

(54) LITHIUM ION CONDUCTOR AND ALL-SOLID-STATE BATTERY COMPRISING THE SAME

(71) Applicant: SAMSUNG ELECTRO-MECHANICS CO., LTD., Suwon-si, Gyeonggi-do (KR)

(72) Inventors: Kyunglock Kim, Suwon-si, Gyeonggi-do (KR); Jieun Wang, Suwon-si, Gyeonggi-do (KR); Youngjin Hwang, Suwon-si, Gyeonggi-do (KR); Won-Seh Lee, Suwon-si, Gyeonggi-do (KR); Bonseok Koo, Suwon-si, Gyeonggi-do (KR); Namgyu Kim, Suwon-si, Gyeonggi-do (KR); Taehoon Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/293,663

(22) PCT Filed: Nov. 30, 2023
(86) PCT No.: PCT/KR2023/019591

§ 371 Date: Jan. 30, 2024

(30) Foreign Application Priority Data
Dec. 9, 2022 (KR) 10-2022-0171534
Mar. 15, 2023 (KR) 10-2023-0033891

(51) Int. Cl. H01M 10/0562

(52) U.S. Cl. CPC H01M 10/0562; H01M 2300/008

(57) ABSTRACT

A lithium ion conductor according to the present disclosure includes a Li element, a B element, an O element, an M element, and an X element and has a peak due to a main crystal phase at diffraction angles (2θ) of 24.5° to 26°, 32° to 34°, 35.5° to 36.2°, 37.5° to 38.5°, 43.5° to 45.5°, or a combination thereof in an X-ray diffraction analysis spectrum using a CuKα ray. The M element is Al, Si, Ge, P, or a combination thereof, and the X element is F, Cl, I, Br, or a combination thereof as a halogen element.

### TECHNICAL FIELD The present disclosure relates to a lithium ion conductor and an all-solid-state battery including the same.

### BACKGROUND ART

Recently, as portable electronic devices are required to be down-sized and used for a long term, high-capacity batteries are required, and safety of the batteries is also required due to the spread of wearable electronic devices. Accordingly, development of an all-solid-state battery using a solid electrolyte instead of a liquid electrolyte is actively progressing.

Since the all-solid-state battery does not use a flammable organic solvent, additional circuitry for safety may be simplified. Therefore, the all-solid-state battery is expected as a technology capable of manufacturing a safe battery with high capacity per unit volume.

In addition, an oxide all-solid-state battery using an oxide electrolyte with lower ionic conductivity (10⁻⁴ S/cm to 10⁻⁶ S/cm) than a sulfide electrolyte (10⁻² S/cm) requires a high-temperature firing process but exhibits excellent stability, compared with a sulfide all-solid-state battery using the sulfide electrolyte which reacts with oxygen and moisture in the air.

The oxide all-solid-state batteries may be fired at a high temperature to increase ionic conductivity, but in order to perform integrally stacking and simultaneously co-firing a solid electrolyte and electrode layers (positive electrode layer and negative electrode layer), the firing should be performed at a lower temperature than a synthesis temperature of the electrodes or less to control a reaction between the solid electrolyte and the electrode layers and to prevent a reaction of an electrode active material of the electrode layers and the solid electrolyte with oxygen in the air.

### DISCLOSURE OF INVENTION

### Advantageous Effects of Invention

According to the lithium ion conductor according to the embodiment, the co-firing method is enabled at a low temperature, and thus there is almost no deterioration of the electrode layer, the interfacial resistance with the electrode layer is low, and the ionic conductivity is high, and power performance of the all-solid-state battery is improved.

However, the various advantageous advantages and effects of the present invention are not limited to the above descriptions, and will be more easily understood in the process of describing specific embodiments of the present invention.

### BRIEF DESCRIPTION OF DRAWINGS

FIG. 1 is a schematic view sequentially showing the process of (a) glassy state (b) crystal nucleation, (c) crystal growth at the center of a crystal nucleus, and (d) conversion into a crystallized glass ceramic according to heat treatment steps of a lithium ion conductor.

FIG. 2 is a graph showing XRD analysis results measured in each process of (a) glassy state, (b) crystal nucleation, (c) crystal growth at the center of a crystal nucleus, and (d) conversion into crystallized glass ceramic according to the heat treatment step of the lithium ion conductor.

FIG. 3 is a transmission electron microscope (TEM) and ion milling cross-section scanning electron microscope (SEM) photograph of the crystal state of the lithium ion conductor according to the heat treatment step.

FIG. 4 is a perspective view schematically illustrating an all-solid-state battery according to an embodiment.

FIG. 5 is a cross-sectional view of an all-solid-state battery according to the embodiment shown in FIG. 4.

FIG. 6 is an exploded perspective view schematically illustrating a unit cell stack structure of the all-solid-state battery according to the embodiment shown in FIG. 4.

FIG. 7 is an ion milling cross-sectional scanning electron microscope (SEM) photograph of a crystal phase included in a lithium ion conductor.

FIG. 8 is a graph showing XRD analysis results of Example 1 before heat treatment.

FIG. 9 is a graph showing XRD analysis results of Example 2 before heat treatment.

FIG. 10 is a graph showing XRD analysis results of Example 3 before heat treatment.

FIG. 11 is a graph showing XRD analysis results of Example 4 before heat treatment.

FIG. 12 is a graph showing XRD analysis results of Example 5 before heat treatment.

FIG. 13 is a graph showing XRD analysis results of Example 6 before heat treatment.

FIG. 14 is a graph showing XRD analysis results of Example 7 before heat treatment.

FIG. 15 is a graph showing XRD analysis results of Example 8 before heat treatment.

FIG. 16 is a graph showing XRD analysis results of Example 9 before heat treatment.

FIG. 17 is a graph showing XRD analysis results of Comparative Example 1 before heat treatment.

FIG. 18 is a graph showing XRD analysis results of Comparative Example 2 before heat treatment.

FIG. 19 is a graph showing XRD analysis results of Comparative Example 3 before heat treatment.

FIG. 20 is a graph showing XRD analysis results of Comparative Example 4 before heat treatment.

FIG. 21 is a graph showing XRD analysis results of Example 1 after heat treatment.

FIG. 22 is a graph showing XRD analysis results of Example 2 after heat treatment.

FIG. 23 is a graph showing XRD analysis results of Example 3 after heat treatment.

FIG. 24 is a graph showing XRD analysis results of Example 4 after heat treatment.

FIG. 25 is a graph showing XRD analysis results of Example 5 after heat treatment.

FIG. 26 is a graph showing XRD analysis results of Example 6 after heat treatment.

FIG. 27 is a graph showing XRD analysis results of Example 7 after heat treatment.

FIG. 28 is a graph showing XRD analysis results of Example 8 after heat treatment.

FIG. 29 is a graph showing XRD analysis results of Example 9 after heat treatment.

FIG. 30 is a graph showing XRD analysis results of Comparative Example 1 after heat treatment.

FIG. 31 is a graph showing XRD analysis results of Comparative Example 2 after heat treatment.

FIG. 32 is a graph showing XRD analysis results of Comparative Example 3 after heat treatment.

FIG. 33 is a graph showing XRD analysis results of Comparative Example 4 after heat treatment.

FIG. 34 illustrates a cross-sectional structure (A) of an entire solid-state battery cell, a cross-sectional structure (B) of a positive electrode, and a cross-sectional structure (C) of a negative electrode according to an embodiment.

FIG. 35 is a graph showing charge/discharge performance of an all-solid-state battery cell manufactured using the lithium ion conductor of Example 1 for 5 cycles.

### BEST MODE FOR CARRYING OUT THE INVENTION

One aspect of the embodiment provides a lithium ion conductor having little deterioration of the electrode layer, low interfacial resistance with the electrode layer, and high ionic conductivity because a co-firing method is enabled at a low temperature.

Another aspect of the embodiment provides a method for preparing the lithium ion conductor.

Another aspect of the embodiment provides an all-solid-state battery having improved power performance due to the lithium ion conductor.

However, the object to be achieved by the embodiments is not limited to the abovementioned object but may be variously expanded without departing from the technical spirit of the embodiments.

The lithium ion conductor according to an embodiment includes a Li element, a B element, an O element, an M element, and an X element, and has a peak due to a main crystal phase at diffraction angles (2θ) of 24.5° to 26°, 32° to 34°, 35.5° to 36.2°, 37.5° to 38.5°, 43.5° to 45.5°, or a combination thereof in an X-ray diffraction analysis spectrum using a CuKα ray. The M element is Al, Si, Ge, P, or a combination thereof and the X element is F, Cl, I, Br, or a combination thereof as a halogen element.

The main crystal phase of the lithium ion conductor may include a compound represented by Chemical Formula 1.

Li₄B₍₇₋ₓ₎MₓO₁₂X [Chemical Formula 1]

In Chemical Formula 1, M is Al, Si, Ge, P, or a combination thereof, X is F, Cl, I, Br, or a combination thereof as a halogen element, and 0≤x<7.

The main crystal phase may include Li₄B₄Al₃O₁₂Cl, Li₄B₇O₁₂Cl, LiAlO₂, LiAl₅O₈, or a combination thereof.

The lithium ion conductor may further include a sub-crystal phase, and the sub-crystal phase may include Li₂SiO₃, LiBO₂, LiBO₃, Li₃P₄, or a combination thereof.

The lithium ion conductor may include glass and a crystal phase, and the glass may include lithium oxide (Li₂O), silicon oxide (SiO₂), boron oxide (B₂O₃), phosphorus oxide (P₂O₅), germanium oxide (GeO₂), aluminum oxide (Al₂O₃), and lithium halide (Li—X). The X element is F, Cl, I, Br, or a combination thereof as a halogen element.

35 to 55 mol % of the lithium oxide (Li₂O), 5 to 15 mol % of the silicon oxide (SiO₂), 30 to 50 mol % of the boron oxide (B₂O₃), 0.1 to 5.0 mol % of the phosphorus oxide (P₂ O₅), 0.1 to 5.0 mol % of the germanium oxide (GeO₂), 0.1 to 10 mol % of the aluminum oxide (Al₂O₃), and 0.5 to 10 mol % of the lithium halide (Li—X) may be included based on 100 mol % of the total glass.

A glass transition temperature (Tg) of the glass may be 380 to 450° C.

A crystallization temperature (T_{c}) of the glass may be 460 to 540° C.

An average grain size of the crystal phase of the lithium ion conductor may be 0.5 μm to 2.0 μm.

The lithium ion conductor may further include a peak at a diffraction angle (2θ) of 21° to 23° in an X-ray diffraction analysis spectrum using a CuKα ray.

The lithium ion conductor may have a crystallinity of greater than or equal to 70% calculated by Equation 1.

$$Crystallinity ( \% ) = [ Ic / ( Ic + Ia ) ] \times 100 \qquad [ Equation 1 ]$$

In Equation 1, Ic is a sum of integrated values of scattering intensities of crystalline peaks in the X-ray diffraction analysis spectrum of the lithium ion conductor, and Ia is a sum of integral values of scattering intensities of amorphous halo in the X-ray diffraction analysis spectrum of the lithium ion conductor.

The lithium ion conductor may have an apparent density of 2.0 to 2.4 g/cm³.

The lithium ion conductor may have room-temperature (20° C.) ionic conductivity of greater than or equal to 1.0×10⁻⁵ [siemens/cm].

A method for preparing a lithium ion conductor according to another embodiment includes heat-treating glass including lithium oxide (Li₂O), boron oxide (B₂O₃), silicon oxide (SiO₂), phosphorus oxide (P₂O₅), germanium oxide (GeO₂), aluminum oxide (Al₂O₃), and lithium halide (Li—X), to prepare a glass ceramic that includes a Li element, a B element, an M element, an O element, and an X element, and has a peak due to a main crystal phase at diffraction angles (2θ) of 24.5° to 26°, 32° to 34°, 35.5° to 36.2°, 37.5° to 38.5°, 43.5° to 45.5°, or a combination thereof in an X-ray diffraction analysis spectrum using a CuKα ray. The M element is Al, Si, Ge, P, or a combination thereof and the X element is F, Cl, I, Br, or a combination thereof as a halogen element.

The glass may include 35 to 55 mol % of the lithium oxide (Li₂O), 5 to 15 mol % of the silicon oxide (SiO₂), 30 to 50 mol % of the boron oxide (B₂O₃), 0.1 to 5.0 mol % of the phosphorus oxide (P₂O₅), 0.1 to 5.0 mol % of the germanium oxide (GeO₂), 0.1 to 10 mol % of the aluminum oxide (Al₂O₃), and 0.5 to 10 mol % of the lithium halide (Li—X) based on 100 mol % of the total glass.

A particle size (D₅₀) of the glass may be 1 μm to 5 μm.

A glass transition temperature (Tg) of the glass may be 380° C. to 450° C.

A crystallization temperature (T_{c}) of the glass may be 460° C. to 540° C.

An all-solid-state battery according to another embodiment includes a solid electrolyte layer and a positive electrode and a negative electrode disposed with the solid electrolyte layer therebetween, wherein one of the solid electrolyte layer, positive electrode, negative electrode, and a combination thereof includes the lithium ion conductor.

The lithium ion conductor may have room-temperature (20° C.) ionic conductivity of greater than or equal to 1.0×10⁻⁵ [siemens/cm].

A lithium ion conductor according to another embodiment includes a main crystal phase including a compound represented Li₄B₍₇₋ₓ₎MₓO₁₂X, wherein, M is Al, Si, Ge, P, or a combination thereof, X is F, Cl, I, Br, or a combination thereof, and 0≤x<7; and a sub-crystal phase including Li₂SiO₃, LiBO₂, LiBO₃, Li₃PO₄, or a combination thereof.

The main crystal phase includes one or more of Li₄B₄Al₃O₁₂Cl, Li₄B₇O₁₂Cl, LiAlO₂, LiAl₅O₈, or a combination thereof.

A method for preparing a lithium ion conductor according to another embodiment includes heat-treating, at a temperature from 450° C. to 500° C., glass including 5 to 55 mol % of lithium oxide (Li₂O), 5 to 15 mol % of silicon oxide (SiO₂), 30 to 50 mol % of boron oxide (B₂O₃), 0.1 to 5.0 mol % of phosphorus oxide (P₂O₅), 0.1 to 5.0 mol % of germanium oxide (GeO₂), 0.1 to 10 mol % of aluminum oxide (Al₂O₃), and 0.5 to 10 mol % of lithium halide (Li—X) based on 100 mol % of the total glass to form a glass ceramic including an amorphous phase and a crystal phase. The X element is F, Cl, I, Br, or a combination thereof as a halogen element.

### Mode for the Invention

Hereinafter, various embodiments of the present invention will be described in detail with reference to the accompanying drawings so that those skilled in the art may easily carry out the present invention. The drawings and description are to be regarded as illustrative in nature and not restrictive. Like reference numerals designate like elements throughout the specification. Further, the accompanying drawings are provided only in order to allow embodiments disclosed in the present specification to be easily understood, and are not to be interpreted as limiting the spirit disclosed in the present specification, and it is to be understood that the present invention includes all modifications, equivalents, and substitutions without departing from the scope and spirit of the present invention. In addition, some constituent elements in the accompanying drawings are exaggerated, omitted, or schematically illustrated, and the size of each constituent element does not entirely reflect the actual size.

In addition, unless explicitly described to the contrary, the word “comprise”, and variations such as “comprises” or “comprising”, will be understood to imply the inclusion of stated elements but not the exclusion of any other elements.

Through the specification, the “stacking direction” refers to a direction in which constituent elements are sequentially stacked or the “thickness direction” perpendicular to the large surface (main surface) of the sheet-shaped constituent elements, which corresponds to a T-axis direction in the drawing. In addition, the “side direction” refers to a direction extending parallel to the large surface (main surface) from the edge of the sheet-shaped constituent elements or a “planar direction,” which corresponds to an L-axis direction in the drawing.

Hereinafter, various embodiments and modifications will be described in detail with reference to the drawings.

A lithium ion conductor according to an embodiment can be used as a battery material such as an all-solid-state battery, for example, a solid electrolyte, an electrode binder, or a coating agent, and includes a Li element, a B element, an O element, an M element, and an X element. The M element is Al, Si, Ge, P, or a combination thereof, and the X element is a halogen element, and may be F, Cl, I, Br, or a combination thereof.

A lithium ion conductor according to an embodiment may include a glass (amorphous phase) and a crystal phase. The crystal phase may include a main crystal phase or a sub-crystal phase.

The glass corresponds to precursor materials of the lithium ion conductor, and includes lithium oxide (Li₂O), silicon oxide (SiO₂), boron oxide (B₂O₃), phosphorus oxide (P₂O₅), germanium oxide (GeO₂), aluminum oxide (Al₂O₃), and lithium halide (Li—X). The X element is a halogen element, and may be F, Cl, I, Br, or a combination thereof.

35 to 55 mol % of the lithium oxide (Li₂O), 5 to 15 mol % of the silicon oxide (SiO₂), 30 to 50 mol % of the boron oxide (B₂O₃), 0.1 to 5.0 mol % of the phosphorus oxide (P₂ O₅), 0.1 to 5.0 mol % of the germanium oxide (GeO₂), 0.1 to 10 mol % of the aluminum oxide (Al₂O₃), and 0.5 to 10 mol % of the lithium halide (Li—X) may be included based on 100 mol % of the total glass.

When the content of the phosphorus oxide (P₂O₅) is greater than 5 mol % based on 100 mol % of the total glass, Li₃PO₄ crystals having very low ionic conductivity of 1.0×10⁻⁹ S/cm are excessively produced, lowering ionic conductivity of the lithium ion conductor. When the content of the phosphorus oxide (P₂O₅) is less than 1 mol % based on 100 mol % of the total glass, the apparent density may be lowered after a heat treatment.

When the content of the lithium halide (Li—X) is greater than 10 mol % based on 100 mol % of the total glass, the deliquescence and hygroscopicity of the lithium halide strongly act, deteriorating ionic conductivity performance or thermal shrinkage density characteristics of the lithium ion conductor. When the content of the lithium halide (Li—X) is less than 0.5 mol % based on 100 mol % of the total glass, the main crystal phase (Li₄B₇O₁₂Cl) is not almost produced, greatly deteriorating performance of the lithium ion conductor.

A glass transition temperature (Tg) of the glass may be 380 to 450° C., or for example, 380 to 440° C. A crystallization temperature (T_{c}) of the glass may be 460 to 540° C., or for example 460 to 500° C.

An average grain size of the crystal phase of the lithium ion conductor may be 0.5 μm to 2.0 μm, or for example, 0.5 μm to 1.5 μm. For example, the average grain size of the crystal phase may be obtained by taking a scanning electron microscope (SEM) image of a cross-section obtained by cutting the lithium ion conductor and measuring maximum major axes of at least 100 crystal phases therefrom to prepare a size distribution curve and calculate D50 thereof.

As will be described, as the lithium ion conductor according to an embodiment is manufactured in a method of generating a crystal nucleus, growing a crystal centering the crystal nucleus, and crystallizing it, in addition to the main crystal, which is a primary phase, a secondary phase may be additionally generated. Through the heat treatment, a portion of the glass (amorphous phase) is converted into a crystal phase, producing a lithium ion conductor, which is a glass ceramic including both the glass (amorphous phase) and the crystal phase.

The main crystal phase of the lithium ion conductor according to an embodiment may include a compound represented by Chemical Formula 1.

Li₄B₍₇₋ₓ₎MₓO₁₂X [Chemical Formula 1]

In Chemical Formula 1, M is Al, Si, Ge, P, or a combination thereof, and X is F, Cl, I, Br, or a combination thereof as a halogen element, and 0≤x<7.

In an embodiment, the main crystal phase may include Li₄B₄Al₃O₁₂Cl, Li₄B₇O₁₂Cl, LiAlO₂, LiAl₅O₈, or a combination thereof.

In an embodiment, the lithium ion conductor may further include sub-crystal phase. The sub-crystal phase may include Li₂SiO₃, LiBO₂, LiBO₃, Li₃PO₄, or a combination thereof.

The lithium ion conductor according to an embodiment may have a peak due to a main crystal phase at diffraction angles (2θ) of 24.5° to 26°, 32° to 34°, 35.5° to 36.2°, 37.5° to 38.5°, 43.5° to 45,5°, or a combination thereof in an X-ray diffraction analysis spectrum using a CuKα ray. For example, the lithium ion conductor may have a peak due to the main crystal phase at a position that is a combination of four or more among positions from diffraction angles (2θ) of 24.5° to 26°, 32° to 34°, 35.5° to 36.2°, 37.5° to 38.5°, and 43.5° to 45.5° in an X-ray diffraction analysis spectrum using a CuKα ray.

For example, the lithium ion conductor may have a peak due to a main crystal phase at a diffraction angle (2θ) of 24.5° to 26°, 32° to 34°, 35.5° to 36.2°, and 43.5° to 45.5° in an X-ray diffraction analysis spectrum using a CuKα ray.

As a specific example, the lithium ion conductor may have a peak due to the main crystal phase at a diffraction angle (2θ) of 24.5° to 26°, 32° to 34°, 35.5° to 36.2°, 37.5° to 38.5°, and 43.5° to 45.5° in an X-ray diffraction analysis spectrum using a CuKα ray.

The lithium ion conductor according to an embodiment may further include a peak at a diffraction angle (2θ) of 21° to 23° in an X-ray diffraction analysis spectrum using a CuKα ray, Referring to Tables 1 and 3, the results may be interpreted as a signal that when the SiO₂ content contained in the glass is reduced, Al₂O₃ content is relatively increased, and the main crystal phase in which LiAlO₂ and LiAl₅O₈ are mixed due to the excess Al₂O₃ is additionally generated.

The lithium ion conductor according to an embodiment may have a crystallinity of greater than or equal to 70% calculated by Equation 1.

$$Crystallinity ( \% ) = [ Ic / ( Ic + Ia ) ] \times 100 \qquad [ Equation 1 ]$$

In Equation 1, Ic is a sum of integrated values of scattering intensities of crystalline peaks in the X-ray diffraction analysis spectrum of the lithium ion conductor, and Ia is a sum of integral values of the scattering intensities of the amorphous halo in the X-ray diffraction analysis spectrum of the lithium ion conductor.

For example, the lithium ion conductor may be calculated with respect to a degree of crystallinity based on a graph obtained through X-ray diffraction spectroscopy. In the X-ray diffraction analysis spectrum, an X ray wavelength λ with an incident angle θ and a lattice interplanar spacing d has a relationship of 2d·sin θ=nλ, which is called to be Bragg equation. Accordingly, when the incident angle is determined, the lattice spacing d may be obtained.

However, since random atomic alignments rather than regular atomic alignments appear in an amorphous material, a plurality of X-ray diffractions do not appear at a specific wavelength, but a wide halo pattern appears in a diffraction angle region of 15° to 35°. In a diffraction angle region of 10° to 60°, a peak at a specific angle but a diffuse halo pattern appears, which judges an amorphous material having crystallinity of 0%, However, the surface of the lithium ion conductor exposed to X-rays, must not contain contaminants other than an organic material. Results, only when measured under conditions free from factors affecting diffraction patterns, may have high reliability.

In addition, when a portion of the precursor material is excessive, insufficient, or excluded, a crystalline peak may be observed due to an unstable network between amorphous phases, but this corresponds to a defective phenomenon.

When crystals exist in the lithium ion conductors, one or more crystalline peaks exist in the corresponding measurement diffraction angle range. The presence of the peak means that a peak may be, in an X-ray diffraction diagram with maximum intensity in a diffraction angle range of (2θ)=5° or more and 50° or less as a full area of a vertical axis in the XRD pattern graph, recognized at least by naked eyes or clearly distinguished and recognized by a waveform processing unit from the background noise. In particular, a main crystal phase peak has 80% of peak intensity of the lowest peak.

Herein, as crystallinity is higher, a halo region is reduced, and when the crystallinity is 100%, there is no halo region. When crystalline and amorphous are mixed, the crystallinity is obtained by calculating a relative ratio of an area of the halo region to that of the crystalline peak region in a graph of intensity and the diffraction angle range.

The apparent density of the lithium ion conductor is measured after the heat treatment at a specific temperature range (a crystallization temperature of glass or higher), which may be in a range of 2.0 to 2.4 g/cm³.

The lithium ion conductor according to an embodiment may have room-temperature ionic conductivity of greater than or equal to 1.0×10⁵ [siemens/cm]. Or, the room-temperature ionic conductivity of the lithium ion conductor may be greater than or equal to 2.0×10⁵ S/cm, but its upper limit is not particularly limited. When a lithium ion conductor satisfying the ionic conductivity range is used, an all-solid-state battery has excellent cycle characteristics during the charge/discharge and may exhibit high power.

According to a method of preparing the lithium ion conductor according to an embodiment, glass including lithium oxide (Li₂O), boron oxide (B₂O₃), silicon oxide (SiO₂), phosphorus oxide (P₂O₅), germanium oxide (GeO₂), aluminum oxide (Al₂O₃), and lithium halide (Li—X) is subjected to heat treatment to prepare a glass ceramic that includes a Li element, a B element, an M element, an O element, and an X element, and has a peak due to a main crystal phase at diffraction angles (2θ) of 24.5° to 26°, 32° to 34°, 35.5° to 36.2°, 37.5°to 38.5°, 43.5° to 45.5°, or a combination thereof in an X-ray diffraction analysis spectrum using a CuKα ray. The M element is Al, Si, Ge, P, or a combination thereof and the X element is F, Cl, I, Br, or a combination thereof as a halogen element. The glass may correspond to a precursor material of the lithium ion conductor.

Before heat treatment of the glass, 35 to 55 mol % of lithium oxide (Li₂O), 5 to 15 mol % of silicon oxide (SiO₂), 30 to 50 mol % of boron oxide (B₂O₃), 0.1 to 5.0 mol % of phosphate (P₂O₅), 0.1 to 5.0 mol % of germanium oxide (GeO₂), 0.1 to 10 mol % of aluminum oxide (Al₂O₃), and 0.5 to 10 mol % of lithium halide (Li—X) based on 100 mol % of the total glass may be mixed.

The glass may have a particle size (D₅₀) of 1 to 5 μm, for example, 2 to 4 μm. In addition, the glass may have a particle size (D₁₀) of 0.5 to 2 μm, for example, 1 to 1.5 μm. Furthermore, the glass may have a particle size (D₉₀) of 3 to 6 μm, for example, 3.5 to 5 μm. In addition, the glass may have a particle size (D₉₀) of 5 to 10 μm, for example, 6 to 8 μm.

When the glass has a particle size (D₅₀) of less than 1 μm, characteristics of the lithium ion conductor may be changed due to elution of the glass component, and when the glass has a particle size (D₅₀) of greater than 5 μm, there may be a problem of not properly forming a thickness of the solid electrolyte layer stacked between the positive electrode layer and the negative electrode layer of a final product.

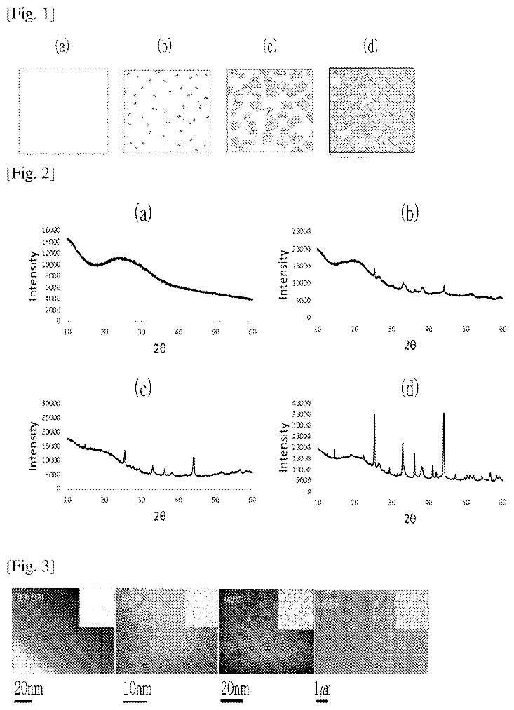

The heat treatment of the glass may include, referring to FIGS. 1 to 3, the following steps 1 to 3.

### Step 1: Crystal Nucleus Generation

When the glass in an amorphous state is heat-treated at a temperature equal to or higher than the glass transition temperature (T_{g}), the glass becomes liquid, and at the same time, lithium oxide (Li₂O) and phosphorus oxide (P₂O₅) reach the state of the following balance equation in the liquid phase to generate crystal nuclei.

$$4 Li X + 2 {LiPO}_{3} + {GeO}_{2} = 2 {Li}_{3} {PO}_{4} + {Ge X}_{4} \qquad [ Balance Equation ]$$

X is F, Cl, I, Br, or a combination thereof as a halogen element.

The glass transition temperature (Tg) of the glass may be 380 to 450° C., or for example, 380 to 440° C.

### Step 2: Crystal Growth at the Center of Crystal Nucleus

Through the continuous heat treatment, crystals grow, while centering small crystal nucleuses. For example, sequential crystallization may occur from Li₂B₄O₇ crystals to Li₄B₇O₁₂Cl crystals, Herein. when aluminum oxide (Al₂O₃) is used in a large amount, a polycrystalline composite of Li₄B₇O₁₂Cl/LiAlO₂/LiAl₅O₈ along with Li₄B₇O₁₂Cl crystals and LiAlO₂/LiAl₅O₈ composite crystals may be produced.

### Step 3: Crystallization

When the heat treatment is performed to a crystallization temperature (T_{c}) of the glass or higher, main crystals such as Li₄B₇O₁₂Cl crystals or Li₄B₄Al₃O₁₂Cl crystals may be completely produced. Herein, in the heat treatment of the glass, the highest temperature may be maintained for 30 to 180 minutes. When the highest temperature is maintained within the range, the main crystal phase may be produced without deteriorating the characteristics of the lithium ion conductor.

A crystallization temperature (T_{c}) of the glass may be 460 to 540° C., or for example 460 to 500° C.

The lithium ion conductor according to an embodiment may be manufactured into glass ceramics all including glass and a crystal phase by heat-treating the glass within the specific temperature range. The lithium ion conductor made of such glass ceramics has specific crystallinity, and much more excellent room-temperature ionic conductivity than before the heat treatment within the specific temperature range. Accordingly, even though the lithium ion conductor is fired at a low temperature of about 500° C. or less, high room-temperature ionic conductivity may be realized.

An all-solid-state battery 100 according to another embodiment includes a solid electrolyte layer and a positive electrode and a negative electrode disposed with the solid electrolyte layer therebetween, wherein any one selected from the solid electrolyte layer, the positive electrode, the negative electrode, and a combination thereof includes the lithium ion conductor.

The lithium ion conductor included in an all-solid-state battery according to an embodiment may have room-temperature (20° C.) ionic conductivity of greater than or equal to 1.0×10⁵ [siemens/cm].

The room-temperature (20° C.) ionic conductivity of the lithium ion conductor included in an all-solid-state battery may be measured in an AC impedance method. For example, the all-solid-state battery may be ion-milled or polished to sample a portion of a solid electrolyte layer including the lithium ion conductor into a flat rectangular piece. Subsequently, at both ends of the obtained piece, electrodes made of gold (Au) are formed, preparing a sample. Then, the sample is measured with respect to AC impedance (frequency: 10⁺⁶ Hz to 10⁻¹ Hz, voltage: 100 mV, 1000 mV) at room temperature (25° C.) by using an impedance measuring, which is used to calculate ionic conductivity.

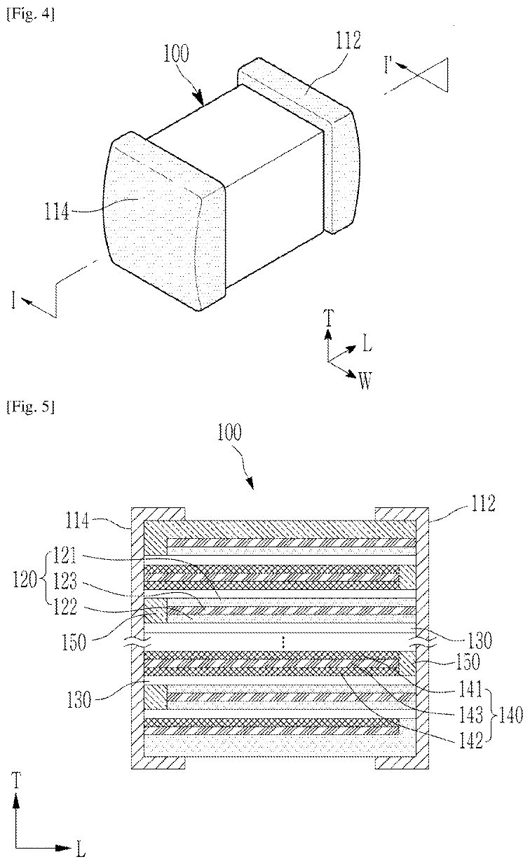

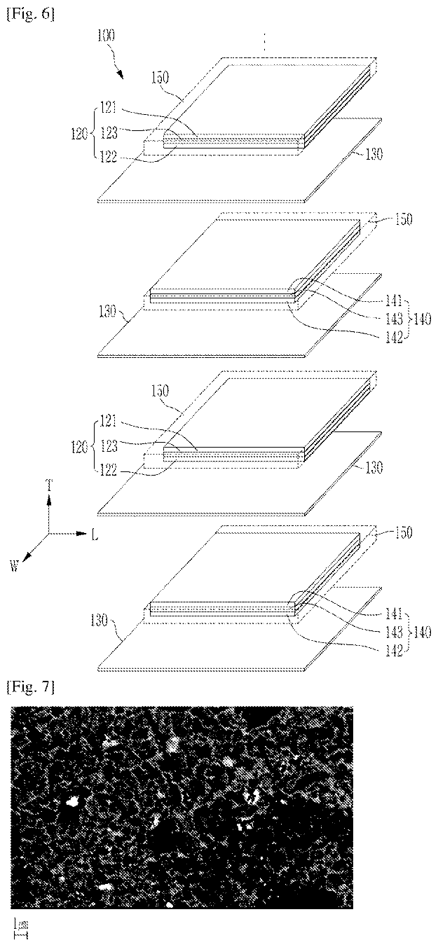

FIG. 4 is a perspective view schematically illustrating an all-solid-state battery according to another embodiment, FIG. 5 is a cross-sectional view of an all-solid-state battery according to the embodiment shown in FIG. 4, and FIG. 6 is an exploded perspective view schematically illustrating a unit cell stack structure of an all-solid-state battery according to the embodiment shown in FIG. 4. Hereinafter, an all-solid-state battery will be described in detail with reference to FIGS. 4 to 6.

The all-solid-state battery 100 may have, for example, an approximate hexahedral shape.

In the present example embodiment, for convenience of description, in the all-solid-state battery 100, both surfaces facing each other in a thickness direction (T-axis direction) are defined as first and second surfaces, and both surfaces connected to the first and second surfaces and facing each other in a length direction (L-axis direction) are defined as third and fourth surfaces. For example, the first and second surfaces of the all-solid-state battery 100 may be the third and fourth surfaces.

The all-solid-state battery 100 according to the present embodiment includes electrode layers 120 and 140 and a solid electrolyte layer 130 adjacent to the electrode layers 120 and 140 in a stacking direction. The electrode layers 120 and 140 may include a positive electrode layer 120 and a negative electrode layer 140, and may basically include the current collectors 123 and 143 and the active material layers 121, 122, 141, and 142 coated on at least one surface of the current collectors 123 and 143.

The positive electrode layer 120 may be formed by coating the positive electrode active material layers 121 and 122 on at least one surface of the positive electrode current collector 123, and the negative electrode layer 140 may be formed by coating the negative electrode active material layers 141 and 142 on at least one surface of the negative electrode current collector 143. For example, the uppermost electrode layer in the stacking direction may be formed by coating the positive electrode active material layer 122 on one surface of the positive electrode current collector 123, and the lowermost electrode layer may be formed by coating the negative electrode active material layer 141 on one surface of the negative electrode current collector 143. In addition, the electrode layers between the uppermost and lowermost ends are formed by coating the positive electrode active material layers 121 and 122 on both surfaces of the positive electrode current collector 123, or by coating the negative electrode active material layers 141 and 142 on both surfaces of the negative electrode current collector 143.

The positive electrode active material layers 121 and 122 may include a positive electrode active material and, optionally, a solid electrolyte. In addition, the positive electrode active material layers 121 and 122 may optionally further include an additive such as a binder or a conductive agent.

For example, the positive electrode active material is not particularly limited as long as it can secure sufficient capacity of the all-solid-state battery 100. For example, the positive electrode active material may include lithium cobalt oxide, lithium nickel cobalt manganese oxide, lithium nickel cobalt aluminum oxide, lithium iron phosphate, lithium manganese oxide, or a combination thereof.

For example, the positive electrode active material may be compounds represented by the following chemical formulas: LiₐA_{1-b}M_{b}D₂ (wherein 0.90≤a≤1.8, 0≤b≤0.5); LiₐE_{1-b}M_{b}O_{2-c}D_{c} (wherein 0.90≤a≤1.8, 0≤b≤0.5, 0≤c≤0.05); LiE_{2-b}M_{b}O_{4-c}D_{c} (wherein 0≤b≤0.5, 0≤c≤0.05); LiₐNi_{1-b-c}Co_{b}M_{c}D_{α} (wherein 0.90≤a≤1.8, 0≤b≤0.5, 0≤c≤0.05, 0<α≤2); LiₐNi_{1-b-c}Co_{b}M_{c}O_{2-α}X_{α} (wherein 0.90≤a≤1.8, 0≤b≤0.5, 0≤c≤0.05, 0<α<2); LiₐNi_{1-b-c}CO_{b}M_{c}O_{2-α}X₂ (wherein 0.90≤a≤1.8, 0≤b≤0.5, 0≤c≤0.05, 0<α<2); LiₐNi_{1-b-c}Mn_{b}M_{c}D_{α} (wherein 0.90≤a≤1.8, 0≤b≤0.5, 0≤c≤0.05, 0<α≤2); LiₐNi_{1-b-c}Mn_{b}M_{c}O_{2-α}X_{α} (wherein 0.90≤a≤1.8, 0≤b≤0.5, 0≤c≤0.05, 0<α<2); LiₐNi_{1-b-c}Mn_{b}M_{c}O_{2-α}X₂ (wherein 0.90≤a≤1.8, 0≤b≤0.5, 0≤c≤0.05, 0<α<2); LiₐNi_{b}E_{c}G_{d}O₂ (wherein 0.90≤a≤1.8, 0≤b≤0.9, 0≤c≤0.5, 0.001≤d≤0.1); LiₐNi_{b}Co_{c}Mn_{d}GeO₂ (wherein 0.90≤a≤1.8, 0≤b≤0.9, 0≤c≤0.5, 0≤d≤0.5, 0.001≤e≤0.1); LiₐNiGbO₂ (wherein 0.90≤a≤1.8, 0.001≤b≤0.1); LiₐCoGbO₂ (wherein 0.90≤a≤1.8, 0.001≤b≤0.1); LiₐMnGbO₂ (wherein 0.90≤a≤1.8, 0.001≤b≤0.1); LiₐMn₂GbO₄ (wherein 0.90≤a≤1.8, 0.001≤b≤0.1); QO₂; QS₂; LiQS₂; V₂O₅; LiV₂O₂; LiRO₂; LiNiVO₄; Li_{(3-f)}J₂(PO₄)₃ (0≤f≤2); Li_{(3-f)}Fe₂(PO₄)₃ (wherein 0≤f≤2); and LiFePO₄, wherein in the above chemical formulas, A is Ni, Co, or Mn; M is Al, Ni, Co, Mn, Cr, Fe, Mg, Sr, V, or a rare-earth element; D is O, F, S, or P; E is Co or Mn; X is F, S, or P; G is Al, Cr, Mn, Fe, Mg, La, Ce, Sr, or V; Q is Ti, Mo, or Mn; R is Cr, V, Fe, Sc, or Y; and J is V, Cr, Mn, Co, Ni, or Cu.

The positive electrode active material may also be LiCoO₂, LiMnₓO₂ₓ (wherein x=1 or 2), LiNi₁₋ₓMnₓO₂ₓ (wherein 0<x<1), LiNi_{1-x-y}CoₓMn_{y}O₂ (wherein 0≤x≤0.5 and 0≤y≤0.5), LiFePO₄, TiS₂, FeS₂, TiS₃, or FeS₃.

The solid electrolyte may include a lithium ion conductor according to an embodiment. A content of the solid electrolyte may be greater than or equal to 0.1 parts by weight, greater than or equal to 1 part by weight, or greater than or equal to 10 parts by weight, and less than or equal to 80 parts by weight, less than or equal to 60 parts by weight, or less than or equal to 50 parts by weight, based on 100 parts by weight of the total amount of the positive electrode active material.

The conductive agent is not particularly limited as long as it has conductivity without causing chemical change in the all-solid-state battery 100. For example, examples of the conductive agent may include: graphite such as natural graphite and artificial graphite; carbon-based substances such as carbon black, acetylene black, ketjen black, channel black, furnace black, lamp black, and summer black; conductive fibers such as carbon fibers and metal fibers; fluorinated carbon; metal powders such as aluminum and nickel powder; conductive whiskers such as zinc oxide and potassium titanate; conductive metal oxides such as titanium oxide; or conductive materials such as polyphenylene derivatives.

A content of the conductive agent may be 1 part by weight to 10 parts by weight, for example, 2 parts by weight to 5 parts by weight, based on 100 parts by weight of the positive electrode active material. When the content of the conductive agent is within the above range, a finally obtained electrode may have excellent conductivity characteristics.

The binder may be used to improve bonding strength between an active material and a conductive agent. The binder may include polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene terpolymer (EPDM), sulfonated EPDM, a styrene butadiene rubber, a fluororubber, or various copolymers, and the like.

A content of the binder may be 1 part by weight to 50 parts by weight, for example, 2 parts by weight to 5 parts by weight, based on 100 parts by weight of the total positive electrode active material. When the content of the binder satisfies the above range, the active material layer may have high bonding strength.

As the positive electrode current collector 123, a porous material such as a mesh or mesh shape may be used, and a porous metal plate such as stainless steel, nickel, or aluminum or a two-dimensional carbon-based material (e.g., graphite) may be used. In addition, the positive electrode current collector 123 may be coated with an oxidation-resistant metal or alloy film to prevent oxidation.

The negative electrode active material layers 141 and 142 may include a negative electrode active material and, optionally, a solid electrolyte. In addition, the negative electrode active material layers 141 and 142 may optionally further include an additive such as a binder or a conductive agent.

The negative electrode active material may be a carbon-based material, silicon, a silicon oxide, a silicon-based alloy, a silicon-carbon-based material composite, tin, a tin-based alloy, a tin-carbon composite, a metal oxide, or a combination thereof, and may include a lithium metal and/or a lithium metal alloy. The carbon-based material may include a two-dimensional carbon-based material, and as a specific example, the carbon-based material may include graphite.

The lithium metal alloy may include lithium and a metal/semi-metal capable of alloying with lithium. For example, the metal/semi-metal capable of alloying with lithium may include Si, Sn, Al, Ge, Pb, Bi, Sb, a Si—Y alloy (wherein Y is an alkali metal, an alkaline-earth metal, Group 13 to Group 16 elements, a transition metal, a rare earth element, or a combination thereof, and Si is not included), a Sn—Y alloy (wherein Y is an alkali metal, an alkaline earth metal, Group 13 to Group 16 elements, a transition metal, or a transition metal oxide such as lithium titanium oxide (Li₄Ti₅O₁₂), a rare earth element, or a combination thereof, and Sn is not included), or MₙOₓ (0<x≤2).

The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or a combination thereof.

In addition, the oxide of a metal/semi-metal capable of alloying with lithium may be lithium titanium oxide, vanadium oxide, lithium vanadium oxide, SnO₂, SiOₓ (0<x<2), and the like. For example, the negative electrode active material may include one or more elements selected from elements of Groups 13 to 16 of the periodic table of elements. For example, the negative electrode active material may include one or more elements selected from the group consisting of Si, Ge, and Sn.

The carbon-based material may be crystalline carbon, amorphous carbon, or mixtures thereof. The crystalline carbon may include graphite, such as natural graphite or artificial graphite in irregular, plate, flake, spherical, or fibrous form. In addition, the amorphous carbon may include soft carbon (low temperature calcined carbon) or hard carbon, a mesophase pitch carbonization product, calcined coke, graphene, carbon black, fullerene soot, carbon nanotubes, carbon fiber, and the like.

The silicon may be Si, SiOₓ (0<x<2, for example 0.5 to 1.5), Sn, SnO₂, a silicon-containing metal alloy, or a mixture thereof. The silicon-containing metal alloy may include, for example, silicon and one or more of Al, Sn, Ag, Fe, Bi, Mg, Zn, In, Ge, Pb, and Ti.

The solid electrolyte may include the lithium ion conductor according to an embodiment. A content of the solid electrolyte may be greater than or equal to 0.1 parts by weight, greater than or equal to 1 part by weight, or less than or equal to 10 parts by weight, less than or equal to 80 parts by weight, less than or equal to 60 part by weight, or less than or equal to 50 parts by weight based on 100 parts by weight of the total amount of the negative electrode active material.

The negative electrode active material layer may also optionally include a conductive agent and a binder as described in the positive electrode active material layer.

The negative electrode current collector 143 may be a mesh or mesh-shaped porous body, and a porous metal plate such as stainless steel, nickel, or aluminum. In addition, the negative electrode current collector 143 may be coated with an oxidation-resistant metal or alloy film to prevent oxidation.

The solid electrolyte layer 130 may be interposed and stacked between the positive electrode layer 120 and the negative electrode layer 140. Therefore, the solid electrolyte layer 130 may be adjacently disposed between the positive electrode active material layers 121 and 122 of the positive electrode layer 120 and the negative electrode active material layers 141 and 142 of the negative electrode layer 140 in the stacking direction. Therefore, in the all-solid-state battery 100, a plurality of positive electrode layers 120 and a plurality of negative electrode layers 140 may be alternately disposed, and a plurality of solid electrolyte layers 130 may be interposed and stacked therebetween. The all-solid-state battery 100 is a stacked all-solid-state battery 100 manufactured by alternately stacking a plurality of positive electrode layers 120 and negative electrode layers 140, and interposing a plurality of solid electrolyte layers 130 therebetween to provide a cell stack, and then co-firing them collectively.

The solid electrolyte layer 130 may include an oxide-based solid electrolyte. For example, the solid electrolyte layer 130 may include the lithium ion conductor according to an embodiment.

The oxide-based solid electrolyte may be a garnet-type, NASICON-type, LISICON-type, perovskite-type, LiPON-type, or amorphous (glass) electrolyte.

The garnet-based solid electrolyte may include lithium-lanthanum zirconium oxide (LLZO) represented by LiₐLa_{b}Zr_{c}O₁₂ such as Li₇La₃Zr₂O₁₂, and the NASICON-based solid electrolyte may include a lithium-aluminum-titanium-phosphate salt (LATP) of Li₁₊ₓAlₓTi₂₋ₓ(PO₄)₃ (0<x<1) in which Ti is introduced into a Li₁₊ₓAlₓM₂₋ₓ(PO₄)₃ (LAMP) (0<x<2, M is Zr, Ti, or Ge) type compound, lithium-aluminum-germanium-phosphate (LAGP) represented by Li₁₊ₓAlₓGe₂₋ₓ(PO₄)₃ (0<x<1) such as Li_{1.3}Al_{0.3}Ti_{1.7}(PO₄)₃ introduced with excess lithium and/or lithium-zirconium-phosphate (LZP) of LiZr₂(PO₄)₃.

In addition, the LISICON-based solid electrolyte may include a solid solution oxide represented by xLi₃AO₄-(1−x)Li₄BO₄ (wherein A is P, As, or V and B is Si, Ge, or Ti) such as Li₄Zn(GeO₄)₄, Li₁₀GeP₂O₁₂ (LGPO), Li_{3.5}Si_{0.5}P_{0.5}O₄, or Li_{10.42}Si(Ge)_{1.5}P_{1.5}Cl_{0.08}O_{11.92}, or a solid solution sulfide represented by Li₄₋ₓM_{1-y}M′_{y}S₄ (wherein M is Si, or Ge and M′ is P, Al, Zn, or Ga) such as Li₂S—P₂S₅, Li₂S—SiS₂, Li₂S—SiS₂—P₂S₅, or Li₂S—GeS₂.

The perovskite-based solid electrolyte may include lithium lanthanum titanate (LLTO) represented by Li₃ₓLa_{2/3-x}□_{1/3-2x}TiO₃ (0<x<0.16, □: vacancy) such as Li_{1/8}La_{5/8} TiO₃. The LiPON-based solid electrolyte may include a lithium phosphorous oxynitride such as Li_{2.8}PO_{3.3}N_{0.46}.

Examples of the amorphous electrolyte include Li₂O—B₂O₃—SiO₂, Li₂O—B₂O₃—P₂O₅, Li₃BO₃—Li₂SO₄, or Li₃BO₃—Li₂CO₃.

The margin layer 150 may be disposed along edges of the positive electrode layer 120 and the negative electrode layer 140. The margin layer 150 may be disposed on the solid electrolyte layer 130 and may be formed laterally adjacent to edges of the positive electrode active material layers 121 and 122 or the negative electrode active material layers 141 and 142. Accordingly, the margin layer 150 may be disposed on the same layer as the positive electrode layer 120 and the negative electrode layer 140.

The margin layer 150 may include an insulating material having an ionic conductivity of less than or equal to 1.0×10⁻⁶ S/cm, and for example, insulating materials such as the aforementioned solid electrolyte material or resin may be included.

For example, the insulating material may be polyolefin such as polyethylene or polypropylene, polyester such as polyethylene terephthalate (PET), polyurethane, or polyimide.

In addition, the margin layer 150 may include an inorganic solid electrolyte including an oxide-based solid electrolyte, a sulfide-based solid electrolyte, or a combination thereof used in the solid electrolyte layer 130. However, the material included in the margin layer 150 is not limited thereto and may include various materials.

The positive electrode layer 120, the solid electrolyte layer 130, the negative electrode layer 140, and the margin layer 150 may be stacked as described above to form a cell stack of the all-solid-state battery 100. A protective layer made of an insulating material may be formed on the upper and lower ends of the cell stack of the all-solid-state battery 100.

In addition, terminals of the positive electrode current collector 123 and the negative electrode current collector 143 are exposed onto both sides of the cell stack of the all-solid-state battery 100, and the external electrodes 112 and 114 are connected to the exposed terminals and combined therewith. In other words, the external electrodes 112 and 114 are connected to the terminal of the positive electrode current collector 123 to form a positive electrode and also, connected to the terminal of the negative electrode current collector 143 to form a negative electrode. When the terminals of the positive electrode current collector 123 and the negative electrode current collector 143 are configured to face in opposite directions from each other, the external electrodes 112 and 114 may also be positioned at both sides, respectively.

The external electrodes 112 and 114 may include a conductive metal and glass.

The conductive metal may include, for example, copper (Cu), nickel (Ni), tin (Sn), palladium (Pd), platinum (Pt), gold (Au), silver (Ag), tungsten (W), titanium (Ti), lead (Pb), or an alloy thereof.

A glass component included in the first and second external electrodes 112 and 114 may have a composition in which an oxide is mixed. The glass component may include, for example, a silicon oxide, a boron oxide, an aluminum oxide, a transition metal oxide, an alkali metal oxide, an alkaline-earth metal oxide, or a combination thereof. Herein, the transition metal may be selected from zinc (Zn), titanium (Ti), copper (Cu), vanadium (V), manganese (Mn), iron (Fe), or nickel (Ni), the alkali metal may be selected from lithium (Li), sodium (Na), or potassium (K), and the alkaline-earth metal may be selected from magnesium (Mg), calcium (Ca), strontium (Sr), or barium (Ba).

A method of forming the first and second external electrodes 112 and 114 is not particularly limited. For example, the method may include dipping the cell stack in a conductive paste including a conductive metal and glass or screen-printing or gravure-printing the conductive paste on the surface of the cell stack. In addition, various methods of applying the conductive paste on the surface of the cell stack or transferring a dry film obtained by drying the conductive paste onto the cell stack may be used.

According to an embodiment, even if the positive electrode, the solid electrolyte layer, and the negative electrode are stacked and fired simultaneously at a low temperature of about 500° C. or less, there is little degradation of the electrode layer, and interface resistance with the electrode layer is small and ionic conductivity of a solid electrolyte layer is high, and thus an all-solid-state battery having excellent power performance such as charge/discharge performance may be manufactured.

Hereinafter, specific examples of the invention are presented. However, the examples described below are only intended to specifically illustrate or explain the invention. and the scope of the invention should not be limited thereto.

### EXAMPLES

### Example 1

Glass powder is prepared by mixing 43 mol % of Li₂O, 11 mol % of SiO₂, 37 mol % of B₂O₃, 1 mol % of P₂O₅, 3 mol % of GeO₂, 1 mol % of Al₂O₃, and 4 mol % of LiCl which are glasses as precursor materials of a lithium ion conductor. Herein, the glass powder has a particle size (D₃₀) of 2.342 μm, a glass transition temperature (T_{g}) of 435.4° C., and a crystallization temperature (T_{c}) of 480° C.

### Examples 2 to 9 and Comparative Examples 1 to 4

Glass powders are prepared to have each powder particle size (D₅₀), glass transition temperature (T_{g}), and crystallization temperature (T_{c}) shown in Table 2 in the same manner as in Example 1 except that mol % of each component included in glass is changed as shown in Table 1.

TABLE 1

| mol % | LiCl | Li₂O | SiO₂ | B₂O₃ | P₂O₅ | GeO₂ | Al₂O₃ |
|---|---|---|---|---|---|---|---|
| Example 1 | 4 | 43 | 11 | 37 | 1 | 3 | 1 |
| Example 2 | 4 | 43 | 7 | 38 | 1 | 3 | 4 |
| Example 3 | 4 | 43 | 9 | 38 | 1 | 3 | 2 |
| Example 4 | 4 | 43 | 10 | 36 | 1 | 3 | 1 |
| Example 5 | 4 | 43 | 11 | 42 | 0 | 0 | 1 |
| Example 6 | 5 | 42 | 9 | 37 | 1 | 3 | 1 |
| Example 7 | 4 | 43 | 11 | 39.5 | 2 | 3 | 1 |
| Example 8 | 4 | 43 | 11 | 39.5 | 0.5 | 3 | 1 |
| Example 9 | 4 | 43 | 11 | 39 | 0 | 3 | 1 |
| Comparative | 0 | 48 | 11 | 36 | 1 | 3 | 1 |
| Example 1 | | | | | | | |
| Comparative | 2 | 43 | 11 | 39 | 1 | 3 | 1 |
| Example 2 | | | | | | | |
| Comparative | 11 | 40 | 9 | 36 | 1 | 3 | 1 |
| Example 3 | | | | | | | |
| Comparative | 0.03 | 43 | 11 | 38 | 1 | 3 | 1 |
| Example 4 | | | | | | | |

TABLE 2

| | Tg-DTA (° C.) | | Powder particle size (μm) | | | |
|---|---|---|---|---|---|---|
| | T_{g} | T_{c} | D10 | D50 | D90 | D99 |
| Example 1 | 435.4 | 480 | 1.054 | 2.342 | 4.233 | 7.842 |
| Example 2 | 426.4 | 485 | 1.202 | 2.204 | 3.922 | 7.697 |
| Example 3 | 432.6 | 485 | 1.124 | 2.385 | 4.355 | 7.654 |
| Example 4 | 434.5 | 485 | 1.108 | 2.445 | 4.512 | 7.954 |
| Example 5 | 433 | 465 | 1.211 | 2.365 | 3.987 | 8.024 |
| Example 6 | 418 | 490 | 1.054 | 2.312 | 3.981 | 8.132 |
| Example 7 | 425 | 496 | 1.112 | 2.354 | 4.020 | 7.884 |
| Example 8 | 431.1 | 485 | 1.210 | 2.408 | 3.963 | 8.031 |
| Example 9 | 380 | 478 | 1.115 | 2.352 | 4.103 | 7.984 |
| Comparative Example 1 | 423 | 484 | 1.117 | 2.411 | 4.235 | 7.354 |
| Comparative Example 2 | 440.2 | 490 | 1.206 | 2.432 | 4.821 | 7.954 |
| Comparative Example 3 | 356 | 485 | 1.253 | 2.264 | 4.032 | 8.002 |
| Comparative Example 4 | 454.3 | 505 | 1.009 | 2.412 | 4.121 | 7.946 |

### EXPERIMENTAL EXAMPLES

The glass powders according to Examples 1 to 9 and Comparative Examples 1 to 4 are heat-treated to each temperature (450° C./475° C./500° C.) in Table 4 to prepare each lithium ion conductor of glass ceramics in which crystalline and amorphous phases are mixed.

FIG. 7 shows an ion milling cross-sectional scanning electron microscope (SEM) of the crystalline phase included in the lithium ion conductor.

A main crystal phase and a sub-crystal phase generated after the heat treatment are shown in Table 3.

Referring to Table 3, in Examples 1 to 9, Li₄B₇O₁₂Cl, LiAlO₂, LiAl₅O₈, or a combination thereof are produced as a main crystal phase, but in Comparative Examples 1 to 4, Li₄B₇O₁₂Cl, LiAlO₂, LiAl₅O₈, or a combination thereof are not produced as a main crystal phase.

TABLE 3

| | main crystal phase | sub-crystal phase (secondary phase) | | | |
|---|---|---|---|---|---|
| Example 1 | Li₄B₇O₁₂Cl | Li₂SiO₃ | LiBO₃ | Li₃PO₄ | |
| Example 2 | Li₄B₇O₁₂Cl, LiAlO₂, LiAl₅O₈ | Li₂SiO₃ | LiBO₂ | Li₃PO₄ | |
| Example 3 | Li₄B₇O₁₂Cl, LiAlO₂, LiAl₅O₈ | Li₂SiO₃ | LiBO₂ | Li₃PO₄ | |
| Example 4 | Li₄B₇O₁₂Cl, LiAlO₂, LiAl₅O₈ | Li₂SiO₃ | LiBO₂ | Li₃PO₄ | |
| Example 5 | Li₄B₇O₁₂Cl | Li₂SiO₃ | LiBO₂ | Li₃PO₄ | |
| Example 6 | Li₄B₇O₁₂Cl | Li₂SiO₃ | LiBO₂ | Li₃PO₄ | |
| Example 7 | Li₄B₇O₁₂Cl, Li₃PO₄ | Li₃PO₄ | LiBO₂ | SiO₂ | |
| Example 8 | Li₄B₇O₁₂Cl | Li₂SiO₃ | LiBO₂ | Li₃PO₄ | |
| Example 9 | Li₄B₇O₁₂Cl | Li₂SiO₃ | LiBO₂ | Li₃PO₄ | |
| Comparative | low quartz (=silicate) | Li₂SiO₃ | SiO₂ | | |
| Example 1 | | | | | |
| Comparative | low quartz (=silicate) | Li₂SiO₃ | SiO₂ | | |
| Example 2 | | | | | |
| Comparative | SiO₂, LiSiO₃ | | | | LiCl•H₂O |
| Example 3 | | | | | |
| Comparative | Li₃PO₄, SiO₂ | Li₂SiO₃ | LiBO₂ | SiO₂ | |
| Example 4 | | | | | |

The following experiment is conducted with the heat-treated lithium ion conductors.

### Experimental Example 1: XRD Evaluation Before/After Heat Treatment of Lithium Ion Conductor

The lithium ion conductors before and after the heat treatment are measured with respect to a diffraction angle (2θ) in an X-ray diffraction analysis spectrum using a CuKα ray (XRD). The measurement is conducted under the following conditions.
Energy: 100 keV
Wavelength: 1.5418 Å
Detector: PANalytical X'Pert Pro Multipurpose Diffractometer with Cu Kα-radiation
Exposure time: 30 minutes
Temperature condition: 25° C. room temperature
Scattering angle: 10° to 60°

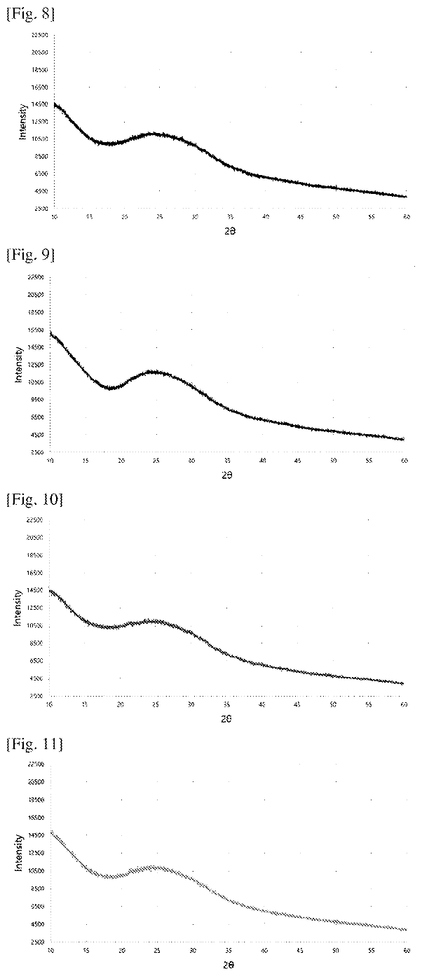

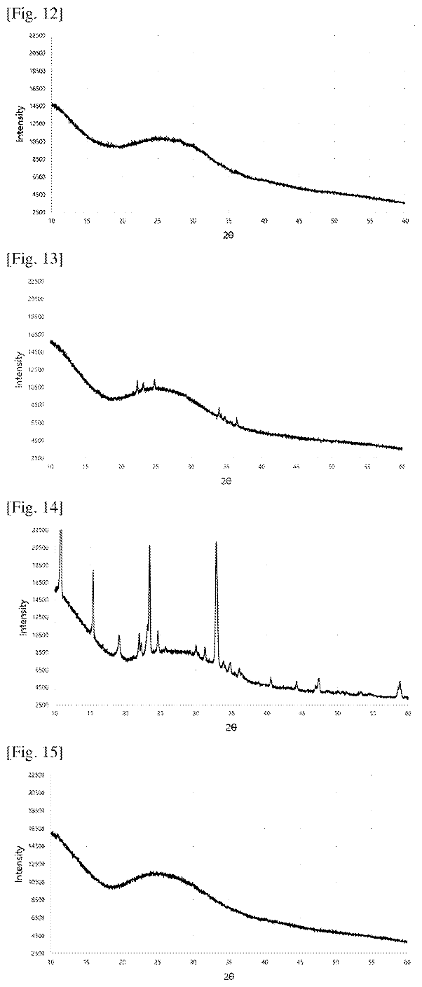

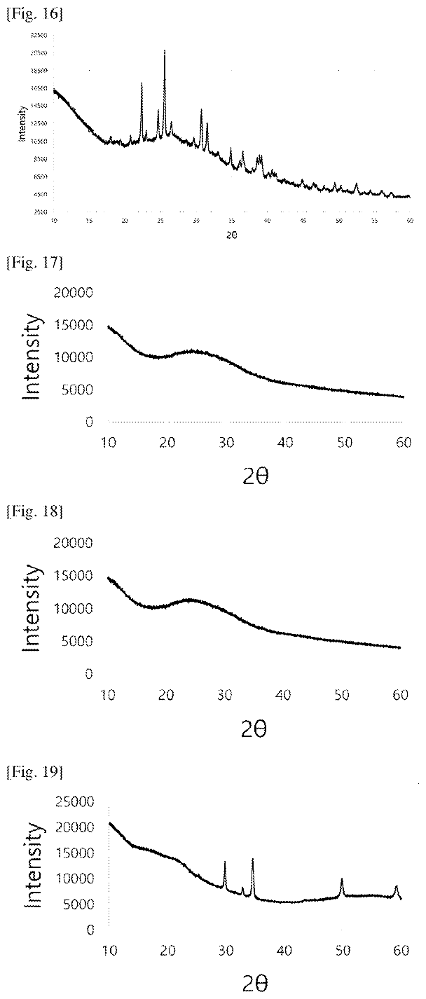

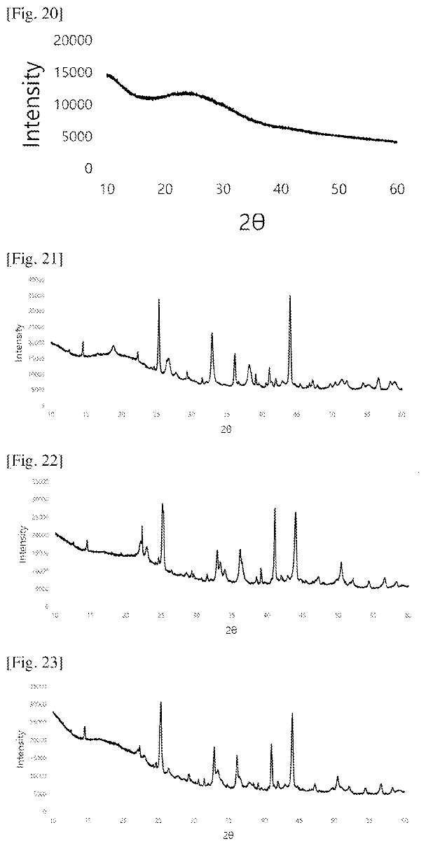

Regarding the lithium ion conductors according to Examples 1 to 9 and Comparative Examples 1 to 4, each lithium ion conductor precursor in a glass powder state before the heat treatment is measured with respect to a diffraction angle (2θ) in an X-ray diffraction analysis spectrum using a CuKα ray (XRD), and the results are shown in FIGS. 8 to 20.

Referring to FIGS. 8 to 20, since the glass powder before the heat treatment is amorphous, a wide halo pattern appears within a diffraction angle range of 10° to 60°. However, Examples 7 and 9 and Comparative Example 3 may have a crystalline peak due to an unstable network between amorphous phases, which corresponds to a defective phenomenon.

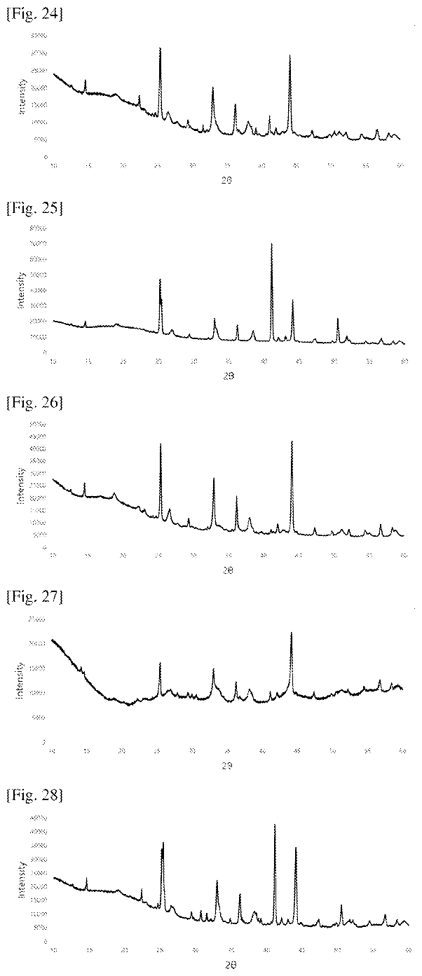

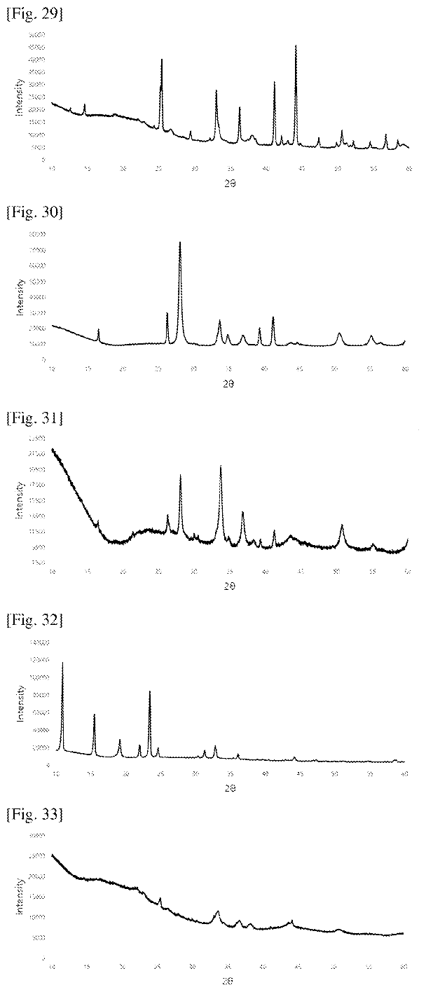

In addition, the lithium ion conductors of Examples 1 to 9 and Comparative Examples 1 to 4 after the heat treatment are measured with respect to a diffraction angle (2θ) in an X-ray diffraction analysis spectrum using a CuKα ray (XRD), and the results are shown in FIGS. 21 to 33. Referring to FIGS. 21 to 33, Examples 1 to 9 have a peak due to a main crystal phase at 24.5° to 26°, 32° to 34°, 35.5° to 36.2°, 37.5° to 38.5°, and 43.5° to 45.5°.

Examples 2 to 4 (FIGS. 22 to 24), since a content of Al₂O₃ is relatively increased due to a small content of SiO₂, as a main crystal phase, in which LiAlO₂ and LiAl₅O₈ are mixed, is additionally produced due to the excess of Al₂O₃, further include a peak at a diffraction angle (2θ) of 21° to 23°.

On the contrary, Comparative Examples 1 to 4 have a peak only at one or two combinations of 24.5° to 26°, 32° to 34°, 35.5° to 36.2°, 37.5° to 38.5°, and 43.5° to 45.5°.

### Experimental Example 2: Measurement of Room-temperature Ionic Conductivity and Apparent Density of Lithium Ion Conductor

The glass powder is compressed under 2 tons in a 14 pi die into a circular pellet and then, heat-treated to a specific temperature (450° C./475° C./500° C.), and the top/bottom surfaces of the sample are polished. Subsequently, the sample is coated with electrodes and then, measured with respect to ionic conductivity [S/cm] at room temperature. The room-temperature ionic conductivity is measured by using an impedance resistor within a voltage range of 20 to 200 mV and a frequency range of 10⁻⁶ Hz.

After heat-treating the samples to a specific temperature (450° C./475° C./500° C.), the lithium ion conductors are measured with respect to apparent density. The apparent density is obtained by measuring a weight of the samples and dividing it by a volume obtained by multiplying a diameter and a thickness.

The results are shown in Table 4.

TABLE 4

| | Heat | Apparent | |
|---|---|---|---|
| | treatment | density | Room-temperature ionic |
| | temperature | (g/cm [symbol] ) | conductivity (S/cm) |
| Example 1 | 450° C. | 2.287 | 5.84 × 10⁸ |
| | 475° C. | 2.29 | 3.42 × 10 [symbol] |
| | 500° C. | 2.27 | 2.88 × 10 [symbol] |
| Example 2 | 450° C. | 2.293 | 1.09 × 10⁴ |
| | 475° C. | 2.062 | 1.80 × 10⁴ |
| | 500° C. | 2.033 | 1.79 × 10⁴ |
| Example 3 | 450° C. | 2.257 | 1.12 × 10⁴ |
| | 475° C. | 2.352 | 4.14 × 10⁵ |
| | 500° C. | 2.177 | 3.40 × 10⁵ |
| Example 4 | 450° C. | 2.232 | 3.10 × 10⁵ |
| | 475° C. | 2.284 | 3.03 × 10⁶ |
| | 500° C. | 2.122 | 3.52 × 10⁵ |
| Example 5 | 450° C. | 2.001 | 6.99 × 10 [symbol] |
| | 475° C. | 2.058 | 1.43 × 10 [symbol] |
| | 500° C. | 2.065 | 1.95 × 10 [symbol] |
| Example 6 | 450° C. | 2.130 | 1.68 × 10⁷ |
| | 475° C. | 2.184 | 2.31 × 10 [symbol] |
| | 500° C. | 2.144 | 3.33 × 10 [symbol] |
| Example 7 | 450° C. | 1.898 | 5.44 × 10⁸ |
| | 475° C. | 2.010 | 4.82 × 10⁷ |
| | 500° C. | 2.001 | 6.65 × 10 [symbol] |
| Example8 | 450° C. | 1.860 | 2.33 × 10⁴ |
| | 475° C. | 1.805 | 1.87 × 10 [symbol] |
| | 500° C. | 1.924 | 1.01 × 10 [symbol] |
| Example 9 | 450° C. | 1.493 | 1.46 × 10⁴ |
| | 475° C. | 1.435 | 1.35 × 10⁴ |
| | 500° C. | 1.626 | 6.37 × 10⁵ |
| Comparative | 450° C. | 2.217 | 4.97 × 10⁹ |
| Example 1 | 475° C. | 2.252 | 4.01 × 10⁹ |
| | 500° C. | 2.202 | not measurable |
| Comparative | 450° C. | 2.217 | not measurable |
| Example 2 | 475° C. | 2.254 | 3.05 × 10⁸ |
| | 500° C. | 2.209 | 1.09 × 10⁸ |
| Comparative | 450° C. | 1.432 | not measurable |
| Example 3 | 475° C. | 1.521 | not measurable |
| | 500° C. | 1.367 | not measurable |
| Comparative | 450° C. | 2.098 | 1.63 × 10⁸ |
| Example 4 | 475° C. | 2.151 | 2.31 × 10⁸ |
| | 500° C. | 2.080 | 7.22 × 10⁹ |

[symbol]

indicates data missing or illegible when filed

Referring to Table 4, the lithium ion conductors of Examples 1 to 9 exhibits room-temperature ionic conductivity of greater than or equal to 1.0×10⁻⁵ (S/cm) after the heat treatment to 500° C. and thus excellent apparent density characteristics after the heat treatment. The lithium ion conductors of Comparative Examples 1, 2, and 4, since Li₄B₇O₁₂Cl as the main crystal phase is not almost produced due to the small content of LiCl, lithium halide, exhibit very low room-temperature ionic conductivity. The lithium ion conductor of Comparative Example 3, since deliquescence and hygroscopicity strongly act due to an excessive content of LiCl, lithium halide, exhibits very deteriorated room-temperature ionic conductivity or apparent density characteristics. In addition, Examples 1 and 2 are measured with respect to apparent density and room-temperature ionic conductivity after a heat treatment to 600° C., 1000° C., which are a relatively higher temperature than 500° C., and the results are shown in Table 5. Referring to Table 5, the lithium ion conductors of Examples 1 and 2, when fired at a high temperature of 600° C. or higher rather than a low temperature, exhibits insufficient apparent density characteristics and too low room-temperature ionic conductivity to be measured.

TABLE 5

| | Heat treatment | Apparent density | Room-temperature ionic |
|---|---|---|---|
| | temperature | (g/cm [symbol] ) | conductivity (S/cm) |
| Example 1 | 600° C. | 1.986 | not measurable |
| | 1000° C. | not measurable | not measurable |
| Example 2 | 600° C. | 1.884 | not measurable |
| | 1000° C. | not measurable | not measurable |

[symbol]

indicates data missing or illegible when filed

### Experimental Example 3: Evaluation of Charge/discharge Performance of All-Solid-State Battery Cell

A 30 μm-thick solid electrolyte layer including the lithium ion conductor of Example 1 is prepared. A positive electrode active material including 70 wt % of LiCoO₂(LCO) and 30 wt % of the lithium ion conductor of Example 1 is formed into a 12 μm-thick positive electrode layer. A negative active material including 70 wt % of graphite and 30 wt % of the lithium ion conductor of Example 1 is formed into a 7 μm-thick negative electrode layer.

The positive electrode layer, the solid electrolyte layer, and the negative electrode layer are stacked and simultaneously, co-fired at 500° C. with a hot press for 30 minutes under 65.8 Mpa, manufacturing an all-solid-state battery cell.

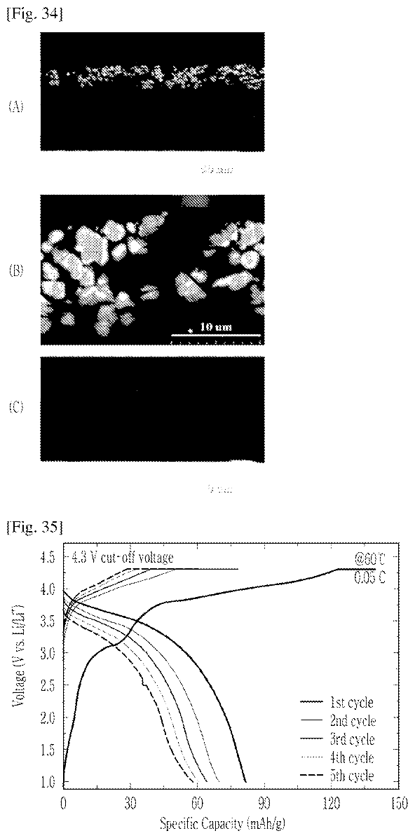

Herein, a cross-section structure (A) of the manufactured all-solid-state battery cell, a cross-section structure (B) of the positive electrode, and a cross-section structure (C) of the negative electrode are shown in FIG. 34.

The all-solid-state battery cell is charged to a maximum voltage of 4.3 V at a constant current of 0.05 c and then, discharged to a cut-off voltage of 3.5 V at 0.05 c, which is regarded as one charge and discharge cycle and 5 cycles repeated, and the characteristic experiment result is shown in FIG. 35.

Referring to FIG. 35, the all-solid-state battery cell exhibits a large ratio of discharge capacity at the 5^{th} cycle to initial discharge capacity at the 1^{st} cycle, that is, large capacity retention and thus excellent battery cycle characteristics and excellent power performance.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### INDUSTRIAL APPLICABILITY

The present disclosure relates to a lithium ion conductor having high ionic conductivity as well as small interfacial resistance with an electrode layer and an all-solid-state battery including the same and thus having excellent power performance, which may be used in devices and electronic devices.

### DESCRIPTION OF SYMBOLS

100: all-solid-state battery
112, 114: external electrode
120: positive electrode layer
121, 122: positive electrode active material layer
123: positive electrode current collector
130: solid electrolyte layer
140: negative electrode layer
141, 142: negative active material layer
143: negative electrode current collector
150: margin layer

1. A lithium ion conductor, comprising:
a Li element, a B element, an O element, an M element, and an X element,
the lithium ion conductor having a peak due to a main crystal phase at diffraction angles (2θ) of 24.5° to 26°, 32° to 34°, 35.5° to 36.2°, 37.5° to 38.5°, 43.5° to 45.5°, or a combination thereof in an X-ray diffraction analysis spectrum using a CuKα ray:
wherein the M element is Al, Si, Ge, P, or a combination thereof, and
the X element is F, Cl, I, Br, or a combination thereof as a halogen element.

2. The lithium ion conductor of claim 1, wherein
the main crystal phase of the lithium ion conductor includes a compound represented by Chemical Formula 1:
Li₄B₍₇₋ₓ₎MₓO₁₂X [Chemical Formula 1]
wherein, in Chemical Formula 1, M is Al, Si, Ge, P, or a combination thereof, X is F, Cl, I, Br, or a combination thereof as a halogen element, and 0≤x<7.

3. The lithium ion conductor of claim 1, wherein
the main crystal phase includes Li₄B₄Al₃O₁₂Cl, Li₄B₇O₁₂Cl, LiAlO₂, LiAl₅O₈, or a combination thereof.

4. The lithium ion conductor of claim 1, further comprising a sub-crystal phase,
wherein the sub-crystal phase includes Li₂SiO₃, LiBO₂, LiBO₃, Li₃PO₄, or a combination thereof.

5. The lithium ion conductor of claim 1, further comprising glass and a crystal phase,
wherein the glass includes lithium oxide (Li₂O), silicon oxide (SiO₂), boron oxide (B₂O₃), phosphorus oxide (P₂O₅), germanium oxide (GeO₂), aluminum oxide (Al₂O₃), and lithium halide (Li—X).

6. The lithium ion conductor of claim 5, wherein
35 to 55 mol % of the lithium oxide (Li₂O), 5 to 15 mol % of the silicon oxide (SiO₂), 30 to 50 mol % of the boron oxide (B₂O₃), 0.1 to 5.0 mol % of the phosphorus oxide (P₂O₅), 0.1 to 5.0 mol % of the germanium oxide (GeO₂), 0.1 to 10 mol % of the aluminum oxide (Al₂O₃), and 0.5 to 10 mol % of the lithium halide (Li—X) are included based on 100 mol % of the total glass.

7. The lithium ion conductor of claim 5, wherein
a glass transition temperature (Tg) of the glass is 380 to 450° C.

8. The lithium ion conductor of claim 5, wherein
a crystallization temperature (T_{c}) of the glass is 460 to 540° C.

9. The lithium ion conductor of claim 5, wherein
an average grain size of the crystal phase of the lithium ion conductor is 0.5 μm to 2.0 μm.

10. The lithium ion conductor of claim 1, wherein
the lithium ion conductor further includes a peak at a diffraction angle (2θ) of 21° to 23° in an X-ray diffraction analysis spectrum using a CuKα ray.

11. The lithium ion conductor of claim 1, wherein
the lithium ion conductor has a crystallinity of greater than or equal to 70% calculated by Equation 1:
$$Crystallinity ( \% ) = [ Ic / ( Ic + Ia ) ] \times 100 \qquad [ Equation 1 ]$$
wherein, in Equation 1, Ic is a sum of integrated values of scattering intensities of crystalline peaks in the X-ray diffraction analysis spectrum of the lithium ion conductor, and
Ia is a sum of integral values of scattering intensities of amorphous halo in the X-ray diffraction analysis spectrum of the lithium ion conductor.

12. The lithium ion conductor of claim 1, wherein
the lithium ion conductor has an apparent density of 2.0 to 2.4 g/cm³.

13. The lithium ion conductor of claim 1, wherein
the lithium ion conductor has room-temperature (20° C.) ionic conductivity of greater than or equal to 1.0×10⁻⁵ [siemens/cm].

14. A method for preparing a lithium ion conductor, comprising
heat-treating glass including lithium oxide (Li₂O), boron oxide (B₂O₃), silicon oxide (SiO₂), phosphorus oxide (P₂O₅), germanium oxide (GeO₂), aluminum oxide (Al₂O₃), and lithium halide (Li—X) to prepare a glass ceramic,
wherein the glass ceramic includes a Li element, a B element, an M element, an O element, and an X element,
the glass ceramic has a peak due to a main crystal phase at diffraction angles (2θ) of 24.5° to 26°, 32° to 34°, 35.5° to 36.2°, 37.5° to 38.5°, 43.5° to 45.5°, or a combination thereof in an X-ray diffraction analysis spectrum using a CuKα ray,
the M element is Al, Si, Ge, P, or a combination thereof, and
the X element is F, Cl, I, Br, or a combination thereof as a halogen element.

15. The method of claim 14, wherein
the glass includes 35 to 55 mol % of the lithium oxide (Li₂O), 5 to 15 mol % of the silicon oxide (SiO₂), 30 to 50 mol % of the boron oxide (B₂O₃), 0.1 to 5.0 mol % of the phosphorus oxide (P₂O₅), 0.1 to 5.0 mol % of the germanium oxide (GeO₂), 0.1 to 10 mol % of the aluminum oxide (Al₂O₃), and 0.5 to 10 mol % of the lithium halide (Li—X) based on 100 mol % of the total glass.

16. The method of claim 14, wherein
a particle size (D₅₀) of the glass is 1 μm to 5 μm.

17. The method of claim 14, wherein
a glass transition temperature (Tg) of the glass is 380 to 450° C.

18. The method of claim 14, wherein a crystallization temperature (T_{c}) of the glass is 460 to 540° C.

19. An all-solid-state battery, comprising
a solid electrolyte layer and a positive electrode and a negative electrode disposed with the solid electrolyte layer therebetween,
wherein one of the solid electrolyte layer, positive electrode, negative electrode, and a combination thereof includes the lithium ion conductor of claim 1.

20. The all-solid-state battery of claim 19, wherein
the lithium ion conductor has room-temperature (20° C.) ionic conductivity of greater than or equal to 1.0×10⁻⁵ [siemens/cm].

21. A lithium ion conductor, comprising:
a main crystal phase including a compound represented Li₄B₍₇₋ₓ₎MₓO₁₂X, wherein, M is Al, Si, Ge, P, or a combination thereof, X is F, Cl, I, Br, or a combination thereof, and 0≤x<7; and
a sub-crystal phase including Li₂SiO₃, LiBO₂, LiBO₃, Li₃PO₄, or a combination thereof.

22. The lithium ion conductor of claim 21, wherein
the main crystal phase includes one or more of Li₄B₄Al₃O₁₂Cl, Li₄B₇O₁₂Cl, LiAlO₂, LiAl₅O₈, or a combination thereof.

23. The lithium ion conductor of claim 21, further comprising glass and a crystal phase,
wherein the glass includes lithium oxide (Li₂O), silicon oxide (SiO₂), boron oxide (B₂O₃), phosphorus oxide (P₂O₅), germanium oxide (GeO₂), aluminum oxide (Al₂O₃), and lithium halide (Li—X).

24. The lithium ion conductor of claim 23, wherein
35 to 55 mol % of the lithium oxide (Li₂O), 5 to 15 mol % of the silicon oxide (SiO₂), 30 to 50 mol % of the boron oxide (B₂O₃), 0.1 to 5.0 mol % of the phosphorus oxide (P₂O₅), 0.1 to 5.0 mol % of the germanium oxide (GeO₂), 0.1 to 10 mol % of the aluminum oxide (Al₂O₃), and 0.5 to 10 mol % of the lithium halide (Li—X) are included based on 100 mol % of the total glass.

25. The lithium ion conductor of claim 24, wherein
an average grain size of the crystal phase of the lithium ion conductor is 0.5 μm to 2.0 μm.

26. The lithium ion conductor of claim 21, wherein
the lithium ion conductor has a crystallinity of greater than or equal to 70% calculated by Equation 1:
$$Crystallinity ( \% ) = [ Ic / ( Ic + Ia ) ] \times 100 \qquad [ Equation 1 ]$$
wherein, in Equation 1, Ic is a sum of integrated values of scattering intensities of crystalline peaks in an X-ray diffraction analysis spectrum of the lithium ion conductor, and
Ia is a sum of integral values of scattering intensities of amorphous halo in the X-ray diffraction analysis spectrum of the lithium ion conductor.

27. The lithium ion conductor of claim 21, wherein
the lithium ion conductor has room-temperature (20° C.) ionic conductivity of greater than or equal to 1.0×10⁻⁵ [siemens/cm].

28. A method for preparing a lithium ion conductor, comprising
heat-treating, at a temperature from 450° C. to 500° C., glass including 5 to 55 mol % of lithium oxide (Li₂O), 5 to 15 mol % of silicon oxide (SiO₂), 30 to 50 mol % of boron oxide (B₂O₃), 0.1 to 5.0 mol % of phosphorus oxide (P₂O₅), 0.1 to 5.0 mol % of germanium oxide (GeO₂), 0.1 to 10 mol % of aluminum oxide (Al₂O₃), and 0.5 to 10 mol % of lithium halide (Li—X) based on 100 mol % of the total glass to form a glass ceramic including an amorphous phase and a crystal phase,
wherein the X element is F, Cl, I, Br, or a combination thereof as a halogen element.

29. The method of claim 28, wherein
a particle size (D₅₀) of the glass is 1 μm to 5 μm.

30. The method of claim 28, wherein
a glass transition temperature (Tg) of the glass is 380 to 450° C.

31. The method of claim 28, wherein a crystallization temperature (T_{c}) of the glass is 460 to 540° C.

32. The method of claim 28, wherein the crystal phase includes one or more of Li₄B₄Al₃O₁₂Cl, Li₄B₇O₁₂Cl, LiAlO₂, LiAl₅O₈, or a combination thereof.
